(19) United States
(12) Patent Application Publication
(10) Pub. No.: US 2004/0225766 A1
(43) Pub. Date: Nov. 11, 2004

(54) Functional pathway configuration at a system/IC interface

(76) Inventors: Ryan Scott Ellison, Mesa, AZ (US); Hartono Darmawaskita, Chandler, AZ (US)

Correspondence Address: BAKER BOTTS, LLP, 910 LOUISIANA, HOUSTON, TX, 77002-4995, US

(21) Appl. No.: 09/769,680

(22) Filed: Jan. 25, 2001

(51) Int. Cl. G06F 13/38; G06F 13/00

(52) U.S. Cl. 710/100

(57) ABSTRACT

The present invention relates generally to functional pathway configurations at the interfaces between integrated circuits (ICs) and the circuit assemblies with which the ICs communicate. More particularly, the present invention relates generally to the functional pathway configuration at the interface between a semiconductor chip including an IC (e.g., computer chips like microcontrollers and microprocessors) and the circuitry of a system including the chip. Even more particularly, the present invention relates to a 20-pin microcontroller functional pathway configuration for the interface between the microcontroller and a system in which the microcontroller is embedded.

### FIELD OF THE INVENTION

The present invention relates generally to functional pathway configurations at the interfaces between integrated circuits (ICs) and the circuit assemblies with which the ICs communicate. More particularly, the present invention relates generally to the functional pathway configuration at the interface between a semiconductor chip including an IC (e.g., computer chips like microcontrollers and microprocessors) and the circuitry of a system including the chip. Even more particularly, the present invention relates to a 20-pin microcontroller functional pathway configuration for the interface between the microcontroller and a system in which the microcontroller is embedded.

### BACKGROUND OF THE INVENTION

The electronics industry is generally divided into two main segments: application products companies and semiconductor companies. The application products companies segment includes the companies that design, manufacture, and sell the wide variety of semiconductor-based goods. The semiconductor companies segment includes integrated circuit (IC) design companies (i.e., fabless companies which may design and/or sell semiconductor chips), foundries (i.e., companies that manufacture chips for others), and partially or fully integrated companies that may design, manufacture, package and/or market chips to application products companies.

There is a large range of semiconductor-based goods available across a broad spectrum of applications, i.e., goods which include one or more semiconductor devices, in applications ranging from manufactured printed circuit boards to consumer electronic devices (stereos, computers, toasters, microwave ovens, etc.) and automobiles (which, for example, include semiconductor devices in fuel injection, anti-lock brake, power windows and other on-board systems). Thus, as one might imagine, there also are a wide variety of semiconductor devices available to meet the various requirements of such products and applications.

Perhaps the two most familiar types of semiconductor devices today are microcontroller and microprocessor computer chips. Microcontrollers, which are the “brains” of a broad range of consumer and industrial applications, differ from microprocessors primarily from the standpoint of the end-user consumer. Typically, consumers concern themselves with the type of microprocessor in a product because the consumers will perceive different performance characteristics or results depending upon the type of microprocessor a product uses (e.g., personal computer applications). Microcontrollers, on the other hand, typically are embedded in an application system and do not enter into the equation when end-user consumers are making purchasing decisions.

Typically, semiconductor companies offer microcontrollers to products companies with a set of features and capabilities appropriate for a particular product or application. Thus, microcontrollers may have a broad range of features and capabilities, and semiconductor companies typically tend to offer their customers a wide range of microcontroller products to meet their customers' needs. For example, a semiconductor company may offer a family of products including a feature-rich “high-end” product (e.g., for automobile applications) and one or more “low-end” products including fewer features (e.g., for household appliance applications).

But while an end-user consumer, concerned only with whether a product works, might be indifferent as to the microcontroller device included in a product, the product designer and manufacturer certainly are not. Product companies generally will expend great efforts to ensure that their products work properly and that consumers receive value and remain satisfied. Thus, product companies tend to select microcontrollers for use in an application based on their features and capabilities, not to mention costs and other factors.

In view of such circumstances, there tends to be vigorous competition amongst semiconductor companies for microcontroller “design wins.” In other words, at the design stage, when a products company is designing a product for a given application, semiconductor companies compete for having their microcontroller included in the product. Once a product company establishes a design and sets or adopts a functional pathway configuration for the interface between a microcontroller and the system in which the microcontroller is embedded, the product company is less likely to change the configuration to accommodate another microcontroller having a different functional pathway configuration. Such configuration changes typically result in increased costs for the product company due to the system in which the microcontroller is embedded having to be re-designed.

While there are a number of factors involved in any decision to award a design win, one such factor comprises a semiconductor company's product “roadmap.” Over time, end-user consumers generally tend to favor future generation consumer products having increased features at lower costs. Accordingly, product companies evaluating microcontroller products of two or more semiconductor companies today will consider whether the particular solutions being offered now will allow them to migrate easily from a basic first generation microcontroller to an enhanced future generation microcontroller having increased capabilities and features. Such migration—without the products company incurring extensive system re-design costs—in general is necessary if the products company is to offer the future generation products that consumers typically demand.

Accordingly, there remains a need for a simple and convenient functional pathway configuration for the interface between a microcontroller and the system in which the microcontroller is embedded, e.g., that tends to promote increased performance with lower costs.

### SUMMARY OF THE INVENTION

The present invention may address one or more of the problems set forth above. Certain possible aspects of the present invention are set forth below as examples. It should be understood that such aspects are presented simply to provide the reader with a brief summary of certain forms the invention might take, and that these aspects are not intended to limit the scope of the invention. Indeed, the invention may encompass a variety of aspects that may not be set forth below.

In one embodiment of the present invention, a functional pathway configuration at the interface between an integrated circuit (IC) and the circuit assembly with which the IC communicates is provided. In a further embodiment, a functional pathway configuration at the interface between a semiconductor chip including an IC (e.g., computer chips like microcontrollers and microprocessors) and the circuitry of a system including the chip is provided. In still a further embodiment, a 20-pin microcontroller functional pathway configuration for the interface between the microcontroller and a system in which the microcontroller is embedded is provided.

In one aspect, the present invention comprises a microcontroller including a plurality of pins. Advantageously, at least one pin comprises a power pin, at least one pin comprises a ground pin, and one or more of the remaining pins are input/output (I/O) pins, wherein each IPO pin may have one or more associated functions. The I/O pins may be analog, digital, or mixed-signal (can be analog or digital). Some I/O pins advantageously are multiplexed with one or more alternate functions for the peripheral features on the microcontroller so that in general when a peripheral is enabled that particular pin may not be used as a general purpose I/O pin.

In one embodiment, a microcontroller in accordance with the present invention advantageously includes twenty pins, including two power pins; two ground pins; a first I/O port including eight pins; and a second I/O port including eight pins. Each pin may be adapted and described according to the function(s) dedicated to the pin, so that all or a portion of the pins together define a functional pathway configuration at the interface between the microcontroller and the system in which the microcontroller may be embedded. Alternately, in another embodiment, the present invention comprises a system for receiving such a microcontroller.

In accordance with the present invention, and depending upon the particular application involved, the IC with which a system interfaces may comprise a packaged IC. Examples of types of packaging include a dual in-line package (DIP), which may comprise molded plastic (PDIP) or ceramic (CERDIP); micro lead frame (MLF); pin grid arrays (PGAs); ball grid arrays (BGAs); quad packages; thin packages, such as flat packs (FPs), thin small outline packages (TSOPs), small outline IC (SOIC) or ultrathin packages (UTPs); lead on chip (LOC) packages; chip on board (COB) packages, in which the chip is bonded directly to a printed-circuit board (PCB); and others. However, for the sake of clarity and convenience only, and without limitation as to the scope of the present invention, reference will be made herein primarily to PDIP ICs.

Table 1 describes an exemplary embodiment in accordance with the present invention including the various functions that the microcontroller may perform, with the functions arranged by pin dedication. Of course the exact pin and function names used in any particular embodiment or application may vary depending upon the naming convention(s) selected. Table 1 is directed to an exemplary embodiment comprising a 20-pin microcontroller. The embodiment described in Table 1 in general may be suited for applications such as consumer and commercial products, including, but not limited to, appliances, telecommunications devices, automobiles, security systems, full house instant hot water heaters, thermostats, and the like. In general, in such applications analog and digital circuit functions are performed, analog inputs are used for receiving sensor information, and/or analog outputs are used for controlling functions.

Tables 2a and 2b describe an embodiment of the present invention including two I/O ports, with each port including pins as shown in the Tables. Table 2a in general describes a first I/O port, and Table 2b in general describes a second I/O port. Each of the pins advantageously is adapted with circuitry to be dedicated to the functions as described herein. Of course the exact form of the circuitry used to create such functionality and adapt such pins may vary depending upon the particular application involved. Without limitation as to the scope of the present invention, Table 3 describes exemplary circuitry in block diagram form for such an embodiment.

### BRIEF DESCRIPTION OF THE DRAWINGS

Further objects and advantages of the present invention will become apparent upon reading the following detailed description and upon referring to the accompanying drawings in which:

FIG. 1 is an illustration of an exemplary embodiment of a functional pathway configuration for the interface between an integrated circuit (IC) and a system with which the IC communicates, in accordance with the present invention.

FIG. 2 is a diagram illustrating an exemplary embodiment of a 20-pin microcontroller including a functional pathway configuration for the interface between the microcontroller and a system in which the microcontroller is embedded, in accordance with the present invention.

FIG. 3 is a diagram illustrating an exemplary embodiment of the integrated circuit shown in FIG. 1 wherein the IC comprises a microcontroller, in accordance with the present invention.

FIG. 4 is an exemplary analog signal multiplexing diagram for the microcontroller shown in FIG. 3, in accordance with the present invention.

The present invention may be susceptible to various modifications and alternative forms.

Specific embodiments of the present invention are shown by way of example in the drawings and are described herein in detail. It should be understood, however, that the description set forth herein of specific embodiments is not intended to limit the present invention to the particular forms disclosed. Rather, all modifications, alternatives, and equivalents falling within the spirit and scope of the invention as defined by the appended claims are intended to be covered.

### DETAILED DESCRIPTION OF SPECIFIC EMBODIMENTS

The description below illustrates embodiments of the present invention. For the sake of clarity, not all features of an actual implementation of the present invention are described in this specification. It should be appreciated that in connection with developing any actual embodiment of the present invention many application-specific decisions must be made to achieve specific goals, which may vary from one application to another. Further, it should be appreciated that any such development effort might be complex and time-consuming, but would still be routine for those of ordinary skill in the art having the benefit of this disclosure.

For the sake of clarity and convenience, aspects of the present invention are described in the context of various embodiments typically used in consumer and industrial applications generally involving, by way of example and without limitation, closed loop control, sensors, switch mode power supplies, etc. However, the present invention may also be useful in a wide variety of other applications.

Also, although the present invention may be used with discrete components, microprocessors, microcontrollers, and other devices and/or combinations thereof, for the sake of clarity and convenience reference is made herein only to microcontrollers.

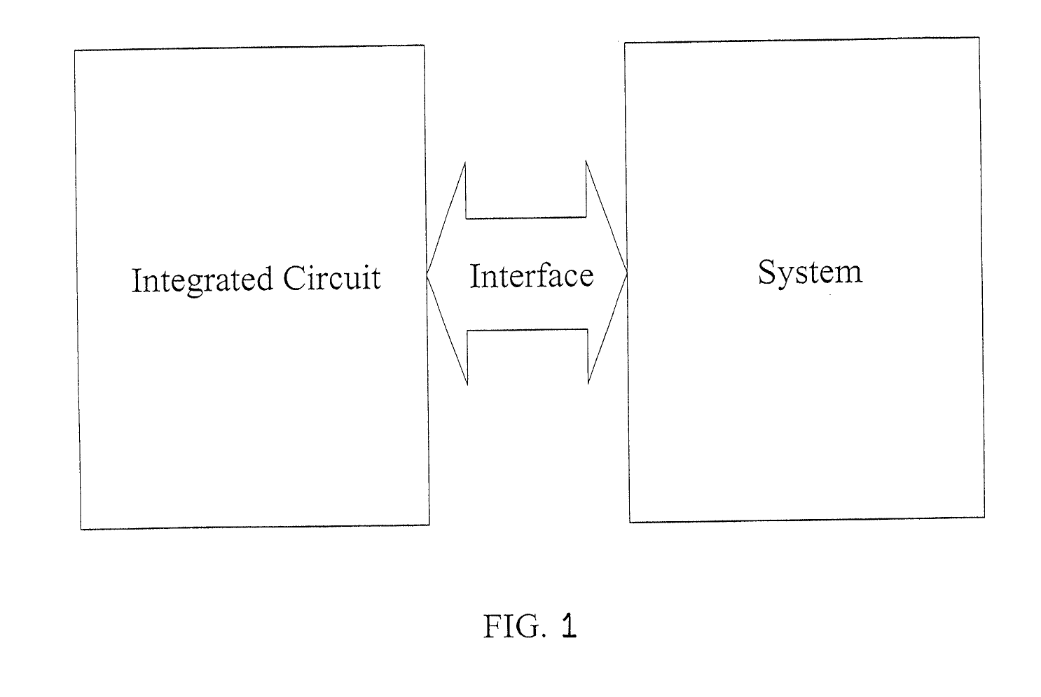

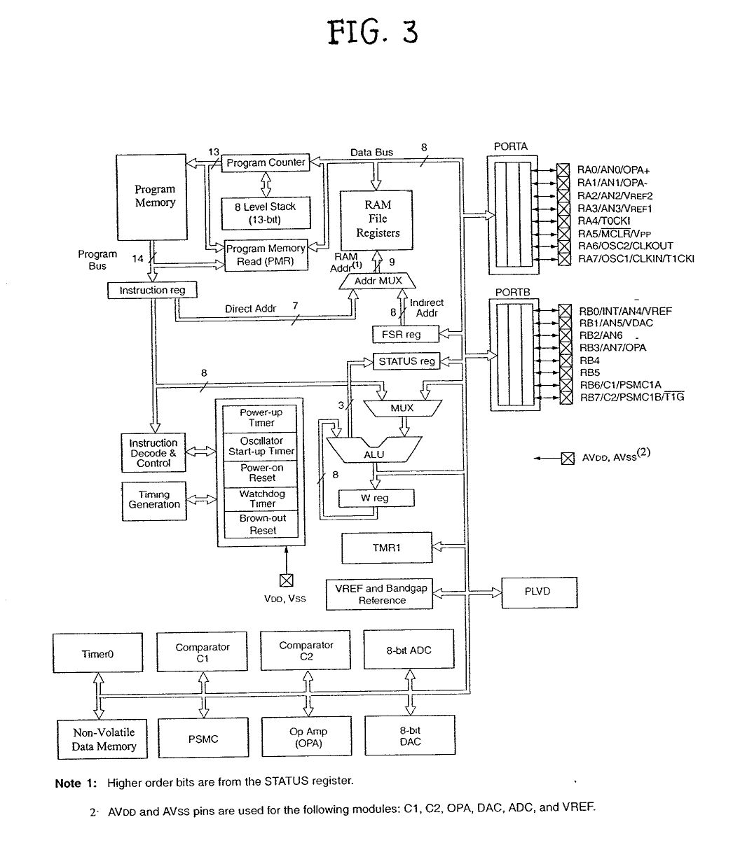

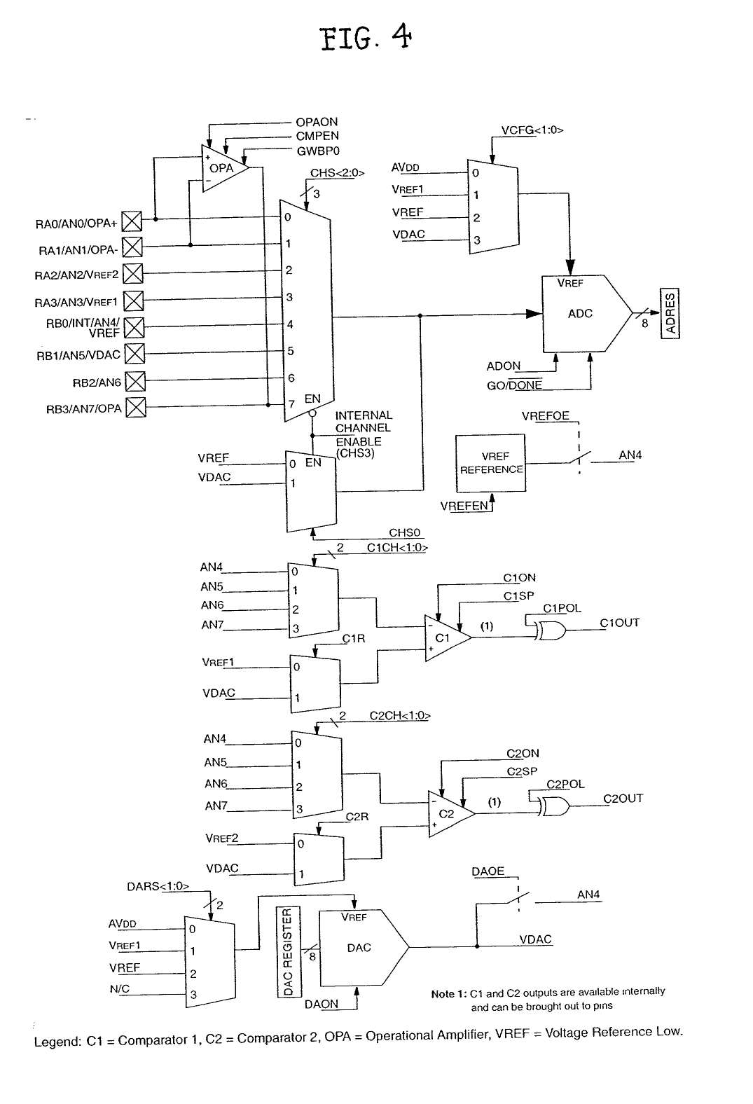

Turning now to the drawings, and by way of general illustration, FIG. 1 comprises a block diagram of an exemplary functionally configured interface between an integrated circuit and a system. FIG. 3 shows in block diagram form an exemplary integrated circuit as illustrated in FIG. 1 comprising a microcontroller. The microcontroller advantageously may be embedded within the system shown in FIG. 1. FIG. 4 shows in block diagram form an exemplary analog signal multiplexing diagram for the microcontroller illustrated in FIG. 3. Of course, the exact form of circuitry used for multiplexing the analog functions and adapting the pins may vary depending upon the circumstances involved in a particular application.

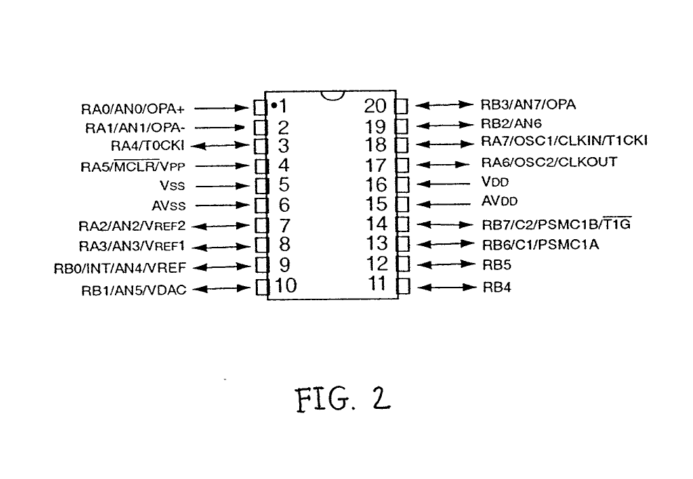

As illustrated in FIG. 2, an exemplary embodiment in accordance with the present invention comprises a PDIP 20-pin microcontroller having a functional pathway configuration, as shown and as described in exemplary fashion herein, for the interface between the microcontroller and the systems (not shown in FIG. 2; see FIG. 1) in which such microcontrollers are embedded.

As shown in FIG. 2, the microcontroller is in general functionally configured with analog on one side of the vertical axis along the length of the package (as opposed to across the package). A configuration including such a feature has as an advantage an increased ability to isolate digital switching noise to one portion of the device. Such advantage may prove beneficial in some cases, e.g., to an applications engineer in situations where partitioning of the printed circuit board in which the microcontroller is to be mounted would prove to be advantageous. In general, such an arrangement permits analog signals being wired to a port on one side portion of the device, and digital signals being wired to a port on the other side portion (which may be viewed along any axis, partition or other boundary).

In the embodiment shown, the pins on which the oscillator functions are multiplexed, labeled RA7/OSC1/CLKIN/TlCKI and RA6/OSC2/CLKOUT (the “OSC1” and “OSC2” pins, respectively), comprise an exception to the above generality concerning separation of analog and digital pins. The OSC1 and OSC2 pins tend to generate noise, and thus advantageously are not disposed on the analog side of the device. Further, in the embodiment shown, the OSC2 pin drives the microcontroller system clock. Thus, the OSC2 pin advantageously is disposed between the OSC1 pin and a power pin. Placing the OSC2 pin next to an I/O pin instead of a power pin might possibly cause a glitch or corruption of the system clock since I/O pins can have high currents and fast transition times which can inductively or capacitively couple to other signals and/or pins. The OSC1 pin, on the other hand, advantageously goes through an internal buffer, and thus is not as susceptible to such coupling although disposed alongside an I/O pin.

Further, the RA7 and RA6 functions are multiplexed with the OSC1 and OSC2 functions, respectively, so that the RB pins can be used for an 8-bit port for byte-wise data transfer regardless of oscillator selection. The multiplexing of the RA7 and RA6 functions with OSC1 and OSC2 functions generally precludes the RA pins from functioning as part of an 8-bit port, unless the OSC1 and OSC2 functions are disabled, e.g., in an embodiment including one or more internal oscillators.

In accordance with the present invention, a subset of the pins may be fixed in particular locations to meet the compatibility requirements of existing development tools intended to be used with the device. For example, in the embodiment of the present invention shown in FIG. 2, the RB6, RB7, VDD, VSS, MCLR, AVDD and AVSS pins comprise such a subset.

Further, a subset of the pins may be fixed in particular locations to meet the requirements of devices such as operational amplifiers (op-amps). For example, in the embodiment of the present invention shown in FIG. 2, pins 1 and 2, which are adjacent and on the same side of the package, comprise such a subset. Similarly, pins 1, 2 and 20 also comprise such a subset, in which pin 20 is generally disposed on the same end of the package as pins 1 and 2, but on the opposite side of the package. Embodiments including such subsets may prove to be particularly advantageous depending upon the circumstances involved in a particular application, e.g., as providing proximity of pins to the op-amp module; as avoiding undesired coupling back to the inputs; for convenience of use in view of board layout (e.g., ease of routing of signals on the board level); etc. In an alternate embodiment, another such subset may include pins 1, 2 and 20 disposed adjacent to one another (in any order). Of course, in these and other embodiments such pin subsets may be shifted or slid along the length of the part and/or disposed in a configuration mirroring another, depending upon the circumstances involved in a particular application.

The present invention has been described in terms of exemplary embodiments. In accordance with the present invention, the parameters for a system may be varied, typically with a design engineer specifying and selecting them for the desired application. Further, it is contemplated that other embodiments, which may be devised readily by persons of ordinary skill in the art based on the teachings set forth herein, may be within the scope of the invention, which is defined by the appended claims. The present invention may be modified and practiced in different but equivalent manners that will be apparent to those skilled in the art having the benefit of the teachings set forth herein.

No limitations are intended to the details or construction or design shown herein, other than as described in the claims appended hereto. Thus, it should be clear that the specific embodiments disclosed above may be altered and modified, and that all such variations and modifications are within the spirit and scope of the present invention as set forth in the claims appended hereto.

TABLE 1

| 20 Pin | | | | Pull-up/ | | |
|---|---|---|---|---|---|---|
| PDIP, | 20 Pin | | Input | Current | Output | |
| SOIC | SSOP | Name | Type | Source | Type | Description |
| 1 | 1 | RA0 | ST | | N/A | Port Input |
| | | AN0 | AN | | — | ADC Input |
| | | OPA+ | AN | | — | Op Amp Non-Inverting Input |
| 2 | 2 | RA1 | ST | | N/A | Port Input |
| | | AN1 | AN | | — | ADC Input |
| | | OPA− | AN | | — | Op amp Inverting Input |
| 7 | 7 | RA2 | ST | | CMOS | Bi-directional I/O |
| | | AN2 | AN | | — | ADC Input |
| | | Vref2 | AN | | — | Voltage Reference Input for C2 Comparator |
| 8 | 8 | RA3 | ST | | CMOS | Bi-directional I/O |
| | | AN3 | AN | | — | ADC Input |
| | | Vref1 | AN | | — | Voltage Reference Input for C1 Comparator, |
| | | | | | | ADC, and DAC Modules |
| 3 | 3 | RA4 | ST | | OD | Bi-directional I/O |
| | | T0CKI | ST | | — | T0 Clock Input |
| 4 | 4 | RA5 | ST | | — | Port Input |
| | | MCLR | ST | No | — | Master Clear Input |
| | | Vpp | Power | | — | Programming Voltage |
| 17 | 17 | RA6 | ST | | CMOS | Bi-directional I/O |
| | | OSC2 | — | | Xtal | Crystal/Resonator |
| | | CLKOUT | — | | CMOS | Internal Clock (Fosc/4) Output |
| 18 | 18 | RA7 | ST | | CMOS | Bi-directional I/O |
| | | OSC1 | Xtal | | — | Crystal/Resonator |
| | | CLKIN | ST | | — | External Clock Input Connection |
| | | T1CKI | ST | | | Timer1 External Clock Input |
| 9 | 9 | RBO | TTL | RBPU | CMOS | Bi-directional I/O with Selectable Pull-up |
| | | | | | | and Interrupt on Change |
| | | INT | ST | | — | Interrupt |
| | | AN4 | AN | | — | ADC, C1, or C2 Comparator Input |
| | | VREF | | | AN | VREF Reference Output |
| 10 | 10 | RB1 | TTL | RBPU | CMOS | Bi-directional I/O with Selectable Pull-up |
| | | | | | | and Interrupt on Change |
| | | AN5 | AN | | — | ADC, C1, or C2 Comparator Input |
| | | VDAC | | | AN | DAC Output |
| 19 | 19 | RB2 | TTL | RBPU | CMOS | Bi-directional I/O with Selectable Pull-up |
| | | | | | | and Interrupt on Change |
| | | AN6 | AN | | — | ADC, C1, or C2 Comparator Input |
| 20 | 20 | RB3 | TTL | RBPU | CMOS | Bi-directional I/O with Selectable Pull-up |
| | | | | | | and Interrupt on Change |
| | | AN7 | AN | | — | ADC, C1, or C2 Comparator Input |
| | | OPA | | | AN | Op Amp Output |
| 11 | 11 | RB4 | TTL | RBPU | CMOS | Bi-directional I/O with Selectable Pull-up |
| | | | | | | and Interrupt on Change |
| 12 | 12 | RB5 | TTL | RBPU | CMOS | Bi-directional I/O with Selectable Pull-up |
| | | | | | | and Interrupt on Change |
| 13 | 13 | RB6 | TTL | RBPU | CMOS | Bi-direclional I/O with Selectable Pull-up |
| | | | | | | and Interrupt on Change |
| | | PSMC1A | | | CMOS | PSMC1A Output |
| | | C1 | | | CMOS | C1 Comparator Output |
| 14 | 14 | RB7 | TTL | RBPU | CMOS | Bi-directional I/O with Selectable Pull-up |
| | | | | | | and Interrupt on Change |
| | | PSMC1B | | | CMOS | PSMC1B Output |
| | | C2 | | | CMOS | C2 comparator Output |
| | | T1G | ST | | — | Timer1 Gate Input |
| 16 | 16 | Vdd | Power | | — | Digital Power |
| 5 | 5 | Vss | Power | | — | Digital Ground |
| 15 | 15 | AVdd | Power | | — | Analog Power |
| 6 | 6 | AVss | Power | | — | Analog Ground |

Legend
ST = Schmitt Trigger Input Voltage Levels,
CMOS = Complimentary Metal Oxide Semiconductor Output Voltage Levels,
TTL = Transistor Transistor Logic Input Voltage Levels,
AN = Analog I/O Voltage Levels,
OD = Open Drain Output,
Xtal = Crystal,
RBPU = Port B Pull-Up

TABLE 2A

| Alternate | PORTA (when not in digital I/O) | | | | | | | |
|---|---|---|---|---|---|---|---|---|
| Function | RA7 | RA6 | RA5 | RA4 | RA3 | RA2 | RA1 | RA0 |
| Low Leakage input | — | — | — | — | — | — | <60 pA | <60 pA |
| only | | | | | | | (tested to | (tested to |
| | | | | | | | 50 nA) | 50 nA) |
| ADC | — | — | — | — | AN3 | AN2 | AN1 | AN0 |
| Op Amp | — | — | — | — | — | — | OPA − Input | OPA + Input |
| VREF Inputs | — | — | — | — | VREF2 | VREF1 | — | — |
| | | | | | Input | Input | | |
| Timer0 | — | — | — | T0CKI | — | — | — | — |
| Timer1 | T1CKI | — | — | — | — | — | — | — |
| Oscillator | OSC1/ | OSC2/ | — | — | — | — | — | — |
| | CLKIN | CLKOUT | | | | | | |
| Reset | — | — | MCLR | — | — | — | — | — |
| Programming | — | — | Vpp | — | — | — | — | — |

Note 1:
Dashed cell implies that the Alternate Function does not apply.

TABLE 2B

| Alternate | PORTB (when not in digital I/O) | | | | | | | |
|---|---|---|---|---|---|---|---|---|
| Function | RB7 | RB6 | RB5 | RB4 | RB3 | RB2 | RB1 | RB0 |
| INT | — | — | — | — | — | — | — | INT |
| ADC | — | — | — | — | AN7 | AN6 | AN5 | AN4 |
| Op amp | — | — | — | — | OPA | — | — | — |
| | | | | | Output | | | |
| C2 comparator | C2 Output | — | — | — | AN7 | AN6 | AN5 | AN4 |
| C1 comparator | — | C1 Output | — | — | AN7 | AN6 | AN5 | AN4 |
| VREF Reference | — | — | — | — | — | — | — | VREF |
| | | | | | | | | Output |
| DAC | — | — | — | — | — | — | — | VDAC |
| | | | | | | | | Output |
| PSMC | PSMC1B | PSMC1A | — | — | — | — | — | — |
| | Output | Output | | | | | | |
| Timer1 | T1G Input | — | — | — | — | — | — | — |
| Programming | Data | Clock | — | — | — | — | — | — |

Note 1:
Dashed cell implies that the Alternate Function does not apply.

[image]

[image]

[image]

[image]

[image]

[image]

[image]

[image]

[image]

What is claimed is:

1. A microcontroller having a functional pathway configuration for the interface between the microcontroller and a system with which the microcontroller communicates, as follows:

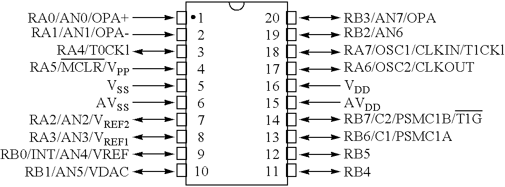

2. A system/IC interface forming a functional pathway configuration including at least two input/output ports comprising:
a first port including a first set of eight pins P1, P2, P3 . . . P8, each of the eight pins of the first set having dedicated functions as follows:

| PIN | DIRECTION | DEDICATED FUNCTION(S) |
|---|---|---|
| P1 | I | RA0/AN0/OPA+ |
| P2 | I | RA1/AN1/OPA− |
| P3 | I/O | RA2/AN2/VREF2 |
| P4 | I/O | RA3/AN3/VREF1 |
| P5 | I/O | RA4/T0CKI |
| P6 | I | RA5/\overline{MCLR}/VPP |
| P7 | I/O | RA6/OSC2/CLKOUT |
| P8 | I/O | RA7/OSC1/CLKIN/T1CKI |

and
a second port including a second set of eight pins P9, P10, P11 . . . P16, each of the eight pins of the second set having dedicated functions as follows:

| PIN | DIRECTION | DEDICATED FUNCTION(S) |
|---|---|---|
| P9 | I/O | RB0/INT/AN4/VREF |
| P10 | I/O | RB1/AN5/VDAC |
| P11 | I/O | RB2/AN6 |
| P12 | I/O | RB3/AN7/OPA |
| P13 | I/O | RB4 |
| P14 | I/O | RB5 |
| P15 | I/O | RB6/C1/PSMC1A |
| P16 | I/O | RB7/C2/PSMC1B/\overline{T1G} |
